(19) United States
(12) Patent Application Publication
(10) Pub. No.: US 2012/0320590 A1
(43) Pub. Date: Dec. 20, 2012

(54) LIGHT-EMITTING DIODE LIGHTS CARRIER

(76) Inventor: AARON SON, Long Beach, CA (US)

(21) Appl. No.: 13/161,258

(22) Filed: Jun. 15, 2011

(51) Int. Cl. F21S 4/00

(52) U.S. Cl. 362/249.02

(57) ABSTRACT

A carrier that securely ties a plurality of LED lights. In addition, the present invention provides a carrier that allows the easy replacement of the LED lights. The carrier includes a first shell, a second shell and an interlocking device to interconnect the first shell to the second shell. The carrier is adapted to carry at least one LED light between the first shell and the second shell.

### BACKGROUND OF THE INVENTION

The present invention relates to a carrier. More particularly, the present invention relates to a carrier for a plurality of light-emitting diode lights (LED lights).

LED lighting displays employ multiple high-brightness LED lights arranged in a regular pattern mounted on a carrier. The LED lights are secured to the carrier by using cable ties, tape, glue, or rope. Unfortunately, these securing practices produce displays on which the LED lights are not securely tied to the carrier or are expensive to replace.

As can be seen, there is a need for a carrier that securely ties the LED lights. In addition, there is a need for a carrier that allows the easy replacement of the LED lights.

### SUMMARY OF THE INVENTION

In one aspect of the present invention, a carrier includes a first shell, a second shell, an interlocking device to interconnect the first shell to the second shell, the carrier is adapted to carry at least one LED light between the first shell and the second shell.

These and other features, aspects and advantages of the present invention will become better understood with reference to the following drawings, description and claims.

### BRIEF DESCRIPTION OF THE DRAWINGS

FIG. 1 illustrates a perspective front view of a carrier according to an exemplary embodiment of the present invention;

FIG. 2 illustrates a perspective front view of the carrier of FIG. 1 showing the carrier in use;

FIG. 3 illustrates a cross-sectional view of the carrier taken along line 3-3 in FIG. 2;

FIG. 4 illustrates a cross-sectional view of the carrier taken along line 4-4 in FIG. 2;

FIG. 5 illustrates an exploded view of the carrier of FIG. 2;

FIG. 6 illustrates a perspective front view of a carrier according to another exemplary embodiment of the present invention;

FIG. 7A illustrates a cross-sectional view a carrier taken alone line 7A-7A in FIG. 6; and

FIG. 7B illustrates an exploded view the carrier of FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a carrier that securely ties a plurality of LED lights. In addition, the present invention provides a carrier that allows the easy replacement of the LED lights.

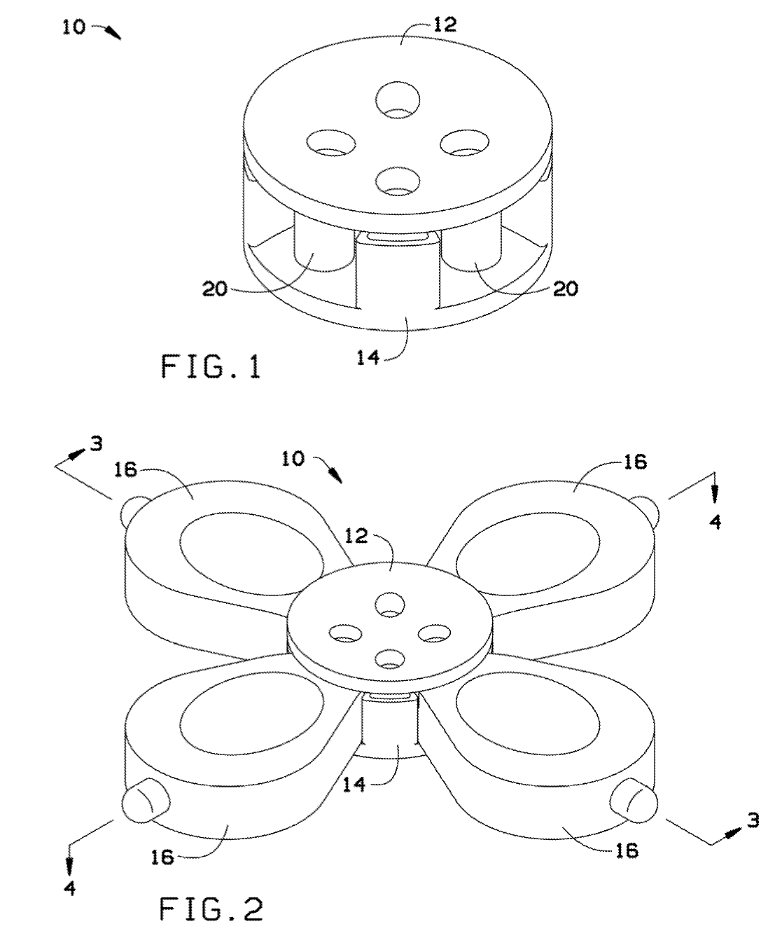

FIG. 1 illustrates a carrier 10 according to an exemplary embodiment of the present invention. The carrier 10 may include a first shell 12 and a second shell 14. The first shell 12 and the second shell 14 may include matching interlocking devices 20 to secure the first shell 12 to the second shell 14.

The first shell 12 and the second shell 14 may be made of a sturdy material. The first shell 12 and the second shell 14 may be made of plastic, metal, wood, polymeric material, composite material, or light rubber. The first shell 12 and the second shell 14 may be manufactured by molding or injection molding. The first shell 12 and the second shell 14 may have a geometrical shape. In some embodiments, the shape of the first shell 12 and the second shell 14 may be round, triangular, square, rectangular, oval, semi-circular, pentagonal, hexagonal, heptagonal, or octagonal. The size of the first shell 12 and the second shell 14 may depend on the shape of the display to be formed.

FIG. 2 illustrates that the carrier 10 may be used to connect and combine a plurality of LED light sources 16 together to form a display. A portion of the body of the LED light source 16 may be hold between the first shell 12 and the second shell 14. In some embodiments, the display may be a toy. The number of LED lights sources 16 that may connect to the carrier 10 may depend on the size of the carrier 10.

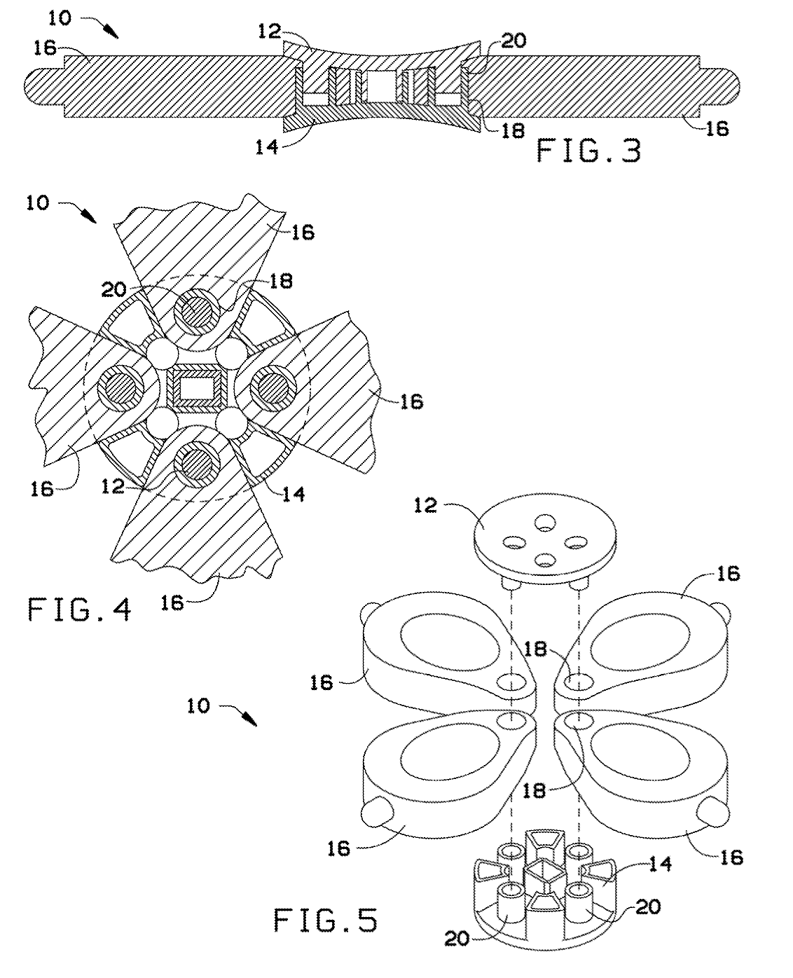

As can be seen from FIGS. 3-4, the interlocking device 20 may allow the first shell 12 to quickly connect and/or disconnect to the second shell 14. The first shell 12 may include at least one female connector and the second shell 14 may include at least one male connector.

The user may place the LED lights 16 on the carrier 10 by aligning a hole 18 on each LED light 16 with the female connector of the interlocking device 20 on the second shell 12. Then, the user may place the first shell 12 on top of the second shell 14 by aligning the male connector of the interlocking device 20 with the female connector. The user may press the first shell 12 against the second shell 14 until both shells snap together. When desired, the user may disconnect the first shell 12 from the second shell 14 by simply pulling both shells 12, 14 apart. The interlocking device 20 may allow the user to quickly connect and disconnect the shells in order to replace the LED lights 16.

In some embodiments, the user may lay the LED lights 16 between the two shells 12, 14 and then press the shells 12, 14 together until both shells snap together. In this embodiment, the LED lights 16 may not be secured to the interlocking device 20.

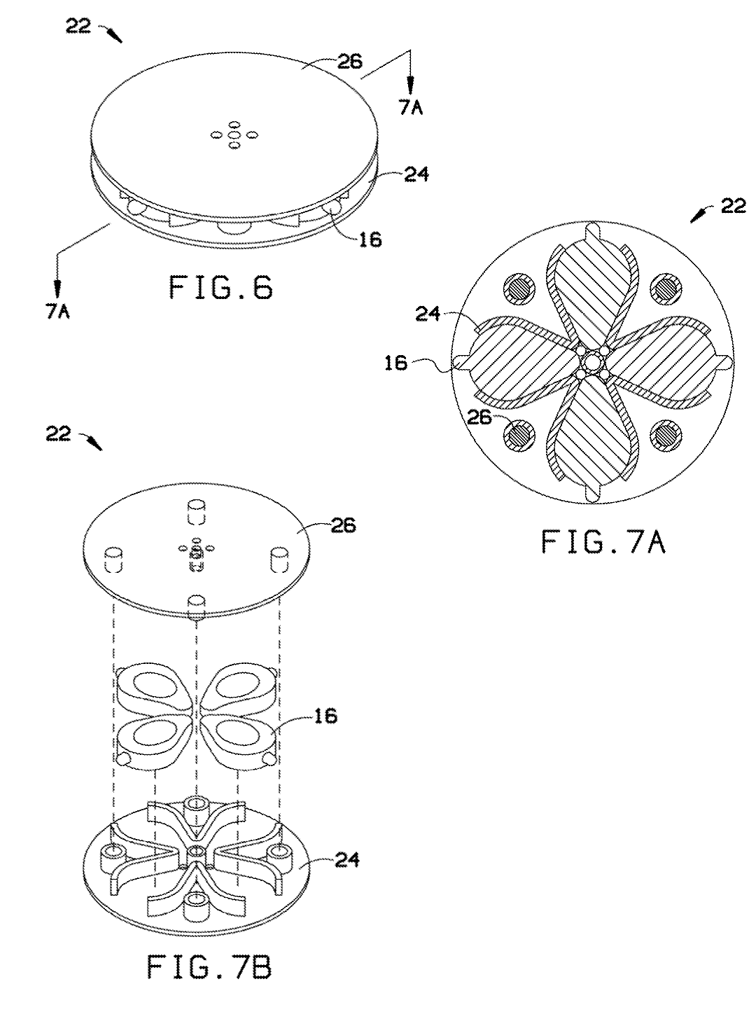

FIG. 6 illustrates a carrier 22 showing another exemplary embodiment of the present invention. In this embodiment, the first shell 24 and the second shell 26 may be design to completely encase the body of the LED light sources 16. As can be seen from FIGS. 6A-6B, only the LED bulbs 26 may protrude from the first shell 24 and the second shell 26.

In some embodiments, the shells 12, 14 may be interconnected and the user may push the LED lights through the space between the shells 12, 14.

In some embodiments, the shells 12, 14 may include cradles to support and guide the LED lights 16 inside the carrier 10.

A hole (not shown) may be included on the first shell 12. The hole (not shown) may allow the user to pass a string (not shown) in order to hang the carrier 10. The string (not shown) may be ropes, cords, or threads of different thickness and diameters.

It should be understood, of course, that the foregoing relates to exemplary embodiments of the invention and that modifications may be made without departing from the spirit and scope of the invention as set forth in the following claims.

What is claimed is:

1. A carrier comprising:
a first shell;
a second shell;
an interlocking device to interconnect the first shell to the second shell;
wherein the carrier is adapted to carry at least one LED light between the first shell and the second shell.

2. The carrier according to claim 1, wherein the interlocking device includes at least one female connector on the second shell and at least one male connector on the first shell.

3. The carrier according to claim 2, wherein each LED light is secured to one of the female connectors and the female connector is interlocked with the corresponding male connector.

4. The carrier according to claim 2, further including a plurality of cradles located on the first shell and the second shell, wherein the cradles support and guide the LED lights inside the carrier.

5. The carrier according to claim 1, wherein the first shell snaps onto the second shell.

6. The carrier according to claim 1, further including a hole located on the first shell, wherein the hole is adapted to pass a string to hang the carrier.

7. The carrier according to claim 1, wherein the first shell and the second shell are made of plastic, metal, wood, polymeric material, composite material, or light rubber.
